(19) United States
(12) Patent Application Publication
(10) Pub. No.: US 2023/0035847 A1
(43) Pub. Date: Feb. 2, 2023

(54) ZONAL DIFFUSE TRACKING

(71) Applicant: Nextracker LLC, Fremont, CA (US)

(72) Inventors: Venkata Rahul Abbaraju, Fremont, CA (US); Yang Liu, Mountain View, CA (US); Eric Martinez, Palo Alto, CA (US)

(21) Appl. No.: 17/877,678

(22) Filed: Jul. 29, 2022

Related U.S. Application Data
(60) Provisional application No. 63/227,622, filed on Jul. 30, 2021.

(51) Int. Cl. H02S 20/32; G05D 3/12

(52) U.S. Cl. CPC H02S 20/32; G05D 3/12

(57) ABSTRACT

A method of controlling a solar array including receiving current and voltage data from a plurality of solar modules of the solar array, calculating a diffuse fraction irradiance for the plurality of solar modules, mapping the diffuse fraction irradiance for the plurality of solar modules, generating a digital image of light conditions in the solar array based on the mapped diffuse fraction irradiance, defining zones within the array based on the light conditions in the digital image, determining a zone-specific solar tracker angle for each zone based on mapped diffuse fraction irradiance, transmitting the zone-specific solar tracker angle to a computing device associated with each solar tracker in the solar array, and driving the solar trackers of each zone such that the solar trackers that make up each zone are oriented to substantially the same angle.

### CROSS-REFERENCE TO RELATED APPLICATIONS

This application claims the benefit of and priority to the filing date of provisional U.S. Patent Application No. 63/227,622, filed Jul. 30, 2021, the entire contents of which is incorporated herein by reference.

### TECHNICAL FIELD

This disclosure is generally directed to single-axis solar tracking systems. More specifically, this disclosure is directed a system and method for controlling a large site of single axis solar trackers such that different zones of the site can be defined and oriented to a position to maximize energy capture based on determination of the cloudiness of the zones, and further for continually updating the definition of the zones as the cloud cover over the site change throughout the day.

### BACKGROUND

There are a variety of techniques and systems employed to identify, anticipate, and act on to rotate single axis solar trackers to an optimum position for energy collection. It is well known that in diffuse light conditions (e.g., cloudy conditions) the optimum angle is a flat or 0° position similar to a position achieved when the sun is directly over the solar tracker. To determine cloudiness there are a variety of techniques that can be employed. Some systems of solar energy collection optimization use satellite imagery to detect cloud cover and to orient the solar trackers appropriately. Others use ground-based photodiodes to determine cloud cover. Still others utilize more advanced global horizontal irradiance (GHI) sensors to determine a total amount of solar radiation incident on a horizontal surface. When the GHI exceeds a predetermined value, as compared to the output of the solar trackers, the solar trackers are placed in diffuse light position. Often however, because the output of a solar tracker that is normally tracking the sun so far exceeds that of a solar tracker in a diffuse light position if any of the solar trackers in an array are not experiencing cloud cover it is best to keep all of the solar trackers in a normal operating mode, even though most of the solar trackers would actually be collecting more energy if they were in a diffuse light position. Thus, the overall output of the solar array is reduced. This lack of granularity in the movement of the solar trackers, particularly in very large arrays or sites can result in a dramatic drop in energy production. Accordingly, improvements to the movement and positioning of solar trackers is desired to improve performance.

### SUMMARY

One aspect of the disclosure is directed to a method of controlling a solar array. The method of controlling also includes receiving current and voltage data from a plurality of solar modules of the solar array; calculating a diffuse fraction irradiance for the plurality of solar modules, mapping the diffuse fraction irradiance (DFI) for the plurality of solar modules, generating a digital image of light conditions in the solar array based on the mapped diffuse fraction irradiance, defining zones within the array based on the light conditions in the digital image, determining a zone-specific solar tracker angle for each zone based on mapped diffuse fraction irradiance, transmitting the zone-specific solar tracker angle to a computing device associated with each solar tracker in the solar array, and driving the solar trackers such that the solar trackers that make up each zone are oriented to substantially the same angle. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The method further including storing the digital image of light conditions in a memory. The method further including generating a forecast digital image of light conditions in the solar array and storing the forecast digital image of light conditions in a memory. If there is a substantial match zones defined from the stored forecast digital image of light conditions and solar tracker angles calculated for each zone are transmitted to the computing device associated with each solar tracker in the solar array. If there is no substantial match the method further includes: defining zones within the array based on the light conditions in the most recent digital image of light conditions in the array; determining a zone-specific solar tracker angle for each zone based on mapped diffuse fraction irradiance in the most recent digital image of light conditions in the array; and transmitting the zone-specific solar tracker angle to a computing device associated with each solar tracker in the solar array. The computing device is one of a self-powered controller (SPC) or a network control unit (NCU). The method further including adjusting the received current and voltage data to account for degradation of the solar modules supported by the solar trackers. The method further including determining one or more of direct normal irradiance (DNI), global horizontal irradiance (GHI), diffuse horizontal irradiance (DHI), any combination of these. The method further including receiving one or more of a satellite images, weather forecasts, and data collected by weather stations. The method further including comparing the satellite images, weather forecasts, or data collected by weather stations to one or more of the DNI, GHI, DFI, and DHI to confirm any cloudiness and near object shading. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

FIG. 1 depicts a large solar array in comprised of a plurality of single axis solar trackers in accordance with the disclosure;

FIG. 2 depicts a schematic of a portion of the solar array of FIG. 1 in accordance with one embodiment of the present disclosure;

FIG. 3 is a perspective view of a portion of a solar tracker of FIG. 1 in accordance with the disclosure;

FIG. 4 is a flow diagram of a method of controlling the solar array of FIG. 1 in accordance with the disclosure;

FIG. 5 is an initial zone map generated based on the average current and voltage data for all solar trackers in communication with a single network control unit in accordance with the disclosure;

FIG. 6 is an initial zone map generated form individual solar tracker current and voltage data in accordance with the disclosure;

FIG. 7 is a flow diagram of a method of controlling the solar array of FIG. 1 in accordance with the disclosure;

FIG. 8 is a flow diagram of a method of controlling the solar array of FIG. 1 in accordance with the disclosure.

### DETAILED DESCRIPTION

This disclosure is directed to systems and method for controlling a large solar array and allow for the definition of multiple zones within the array. The zones are defined based in part on the current and voltage data received from the reference solar panels, which as described below can be used to calculate an estimated global horizontal irradiance (GHI) and a to diffuse fraction irradiance (DFI) experienced by the individual solar tracker. Other inputs include satellite imagery, local forecast data, and observed weather conditions data. Based on these factors a digital diffuse light image of the array is generated depicting those portions of the array experiencing cloud cover and near shading (e.g., caused by landscape, neighboring trackers, buildings, and the like. Based on the digital diffuse light image zones of the array are defined. As such a zone may comprise one or a number of solar trackers and even the entire site. Once defined, the determination of which zone each solar tracker is in is transmitted to the control units for each solar tracker. Control of the solar trackers, however, may be based on the actual sensed GHI as output by sensors in, for example, a weather station. That is the zones are defined as above, but the positioning of the solar trackers in those zones is based on the sensed conditions. This process of developing a digital diffuse light image can be repeated at intervals as desired (e.g., every 1 minute, 2 minutes, 5 minutes, 10 minutes, etc.). By repeatedly updating the definition of the zones, each solar tracker may have its output managed in accordance with the cloud cover and near shading over the array to increase the overall yield of the array throughout the day.

In addition, a predictor can be employed to predict the future evolution of the digital image of the solar array. These predictions can be based on variables including the current local and regional weather conditions and forecast data (including satellite imagery), observed changes and rate of changes in prior digital diffuse light images captured on that day, and other historical data. This prediction can be compared to actual observed changes in the digital diffuse light image and machine learning, neural networks, artificial intelligence, etc., can be used to refine the models employed by the predictor. The systems and methods described herein are particularly useful for very large arrays where the site may be a mile or more in length width. It is with these large arrays that disparities in cloud cover occur most frequently and have an outsized impact on yield from the array. Those of skill in the art will recognize that the disclosure is not so limited to such large arrays and the systems and methods described herein may be employed in smaller arrays as well.

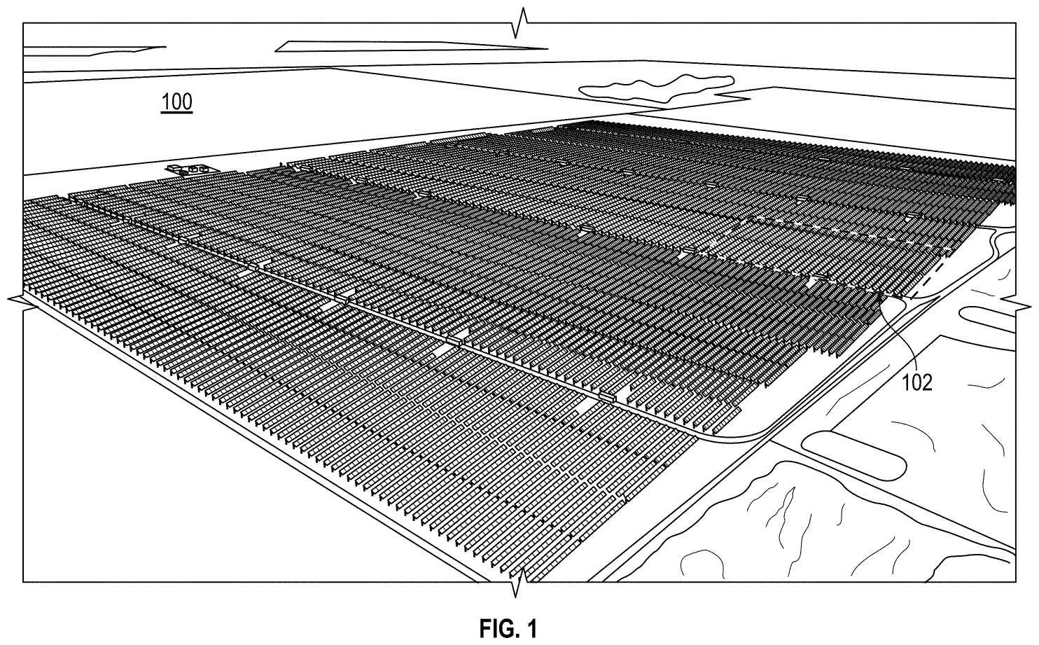

FIG. 1 shows an overhead view of a solar array 100 comprised of a large number of single axis solar trackers 110. Each of the solar tracker 110 has mounted thereon a plurality of solar modules 112 for receiving solar radiation and converting the solar radiation into electrical energy. As will be appreciated the solar modules 112 In some embodiments this electrical energy may be stored in a battery and for distribution to a load. There are known a variety of performance models that can be used to predicting the output of the solar array 100 and, used to orient each of the solar trackers 110 relative to the sun to optimize the total energy output. These performance modules may be based in part on the topography of the area on which the solar array 100 is built, observed local weather conditions, predicted weather conditions, the height of the solar trackers 110, the spacing between the solar trackers 110 and other factors. For example, if the solar modules 112 of one solar tracker 110 shades or partially shades the solar modules 112 of an adjacent solar tracker 110 at certain times of the day, so called near object shading, a backtracking algorithm may be employed to maximize output of the solar array 100 by altering one or both the angles of the solar trackers 110. In other words, due to shading at a particular time of day or other relationships between a first solar tracker 110 and an adjacent solar tracker 110, maximizing the global energy output by the entire solar array 100 does not necessarily correspond to maximizing the energy output by the either the first or the second solar tracker 110 at any particular time of the day. Instead, the global energy output might be maximized by coordinating the outputs, such as by orienting the first solar tracker 100 to generate 80% of its maximum and the second solar tracker 110 to generate 40% of its maximum. The performance model determines these coefficient or gains (and thus the orientation angles to the sun) for each of the solar trackers in the array 100.

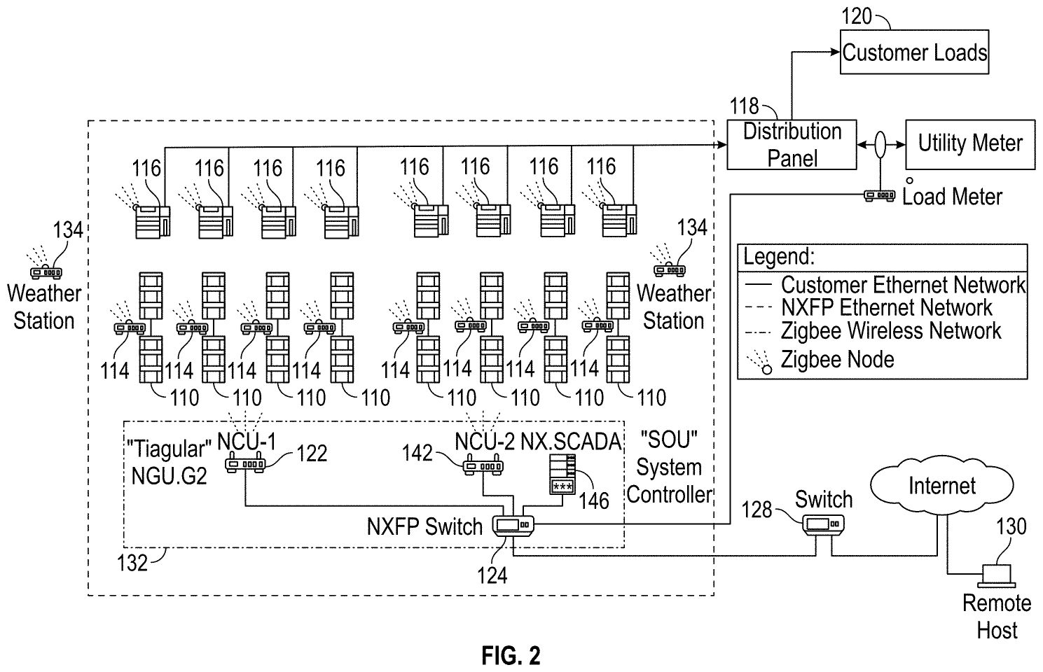

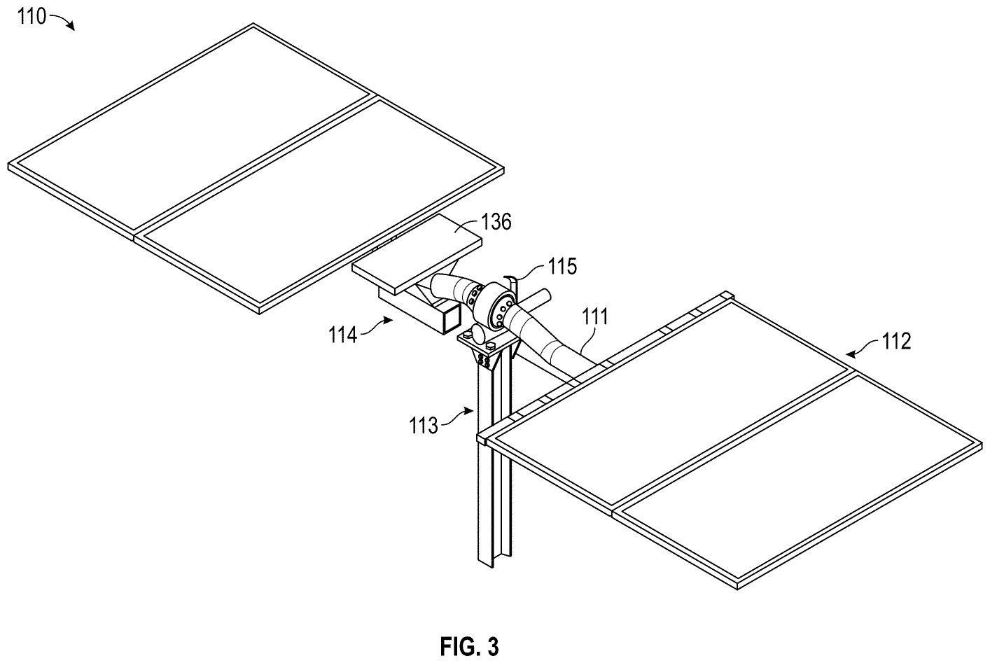

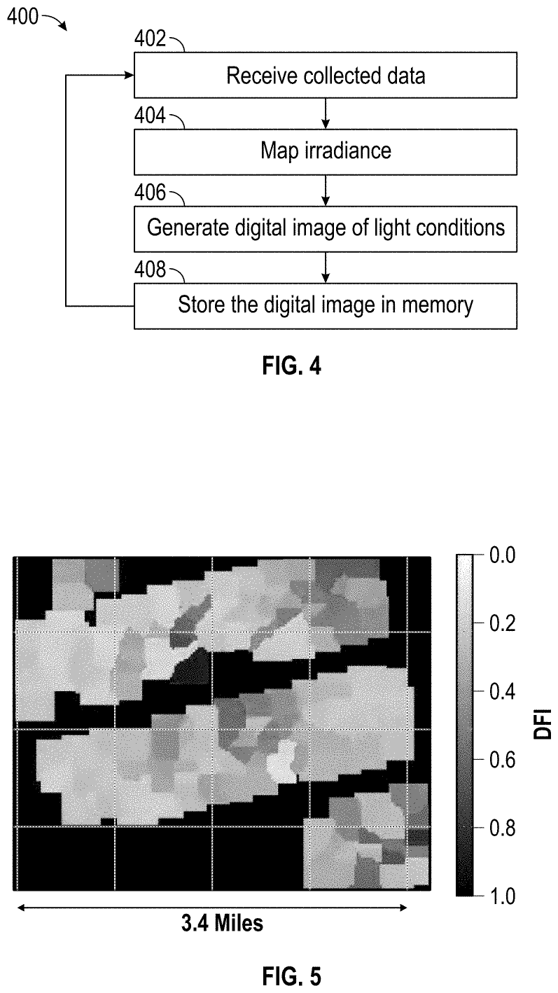

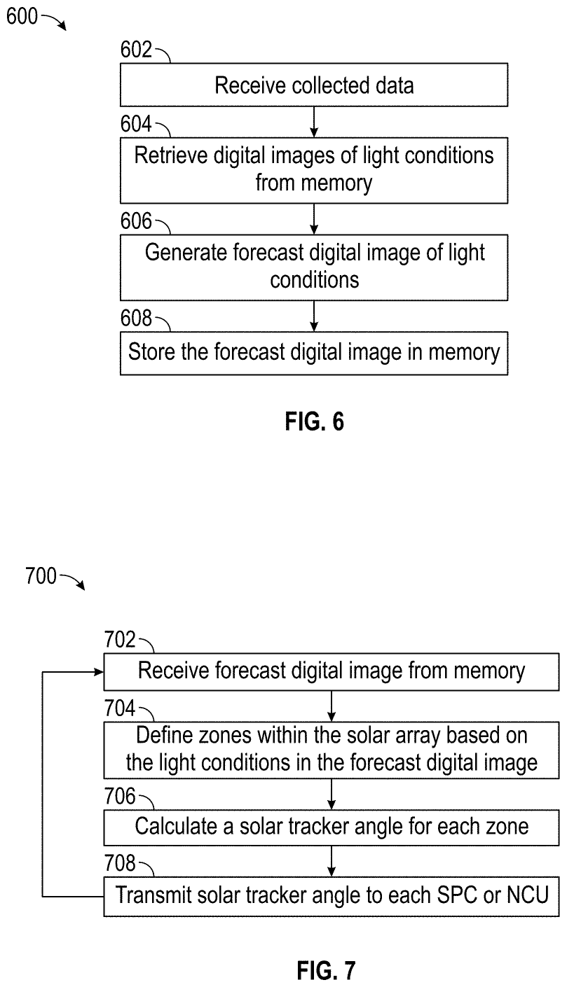

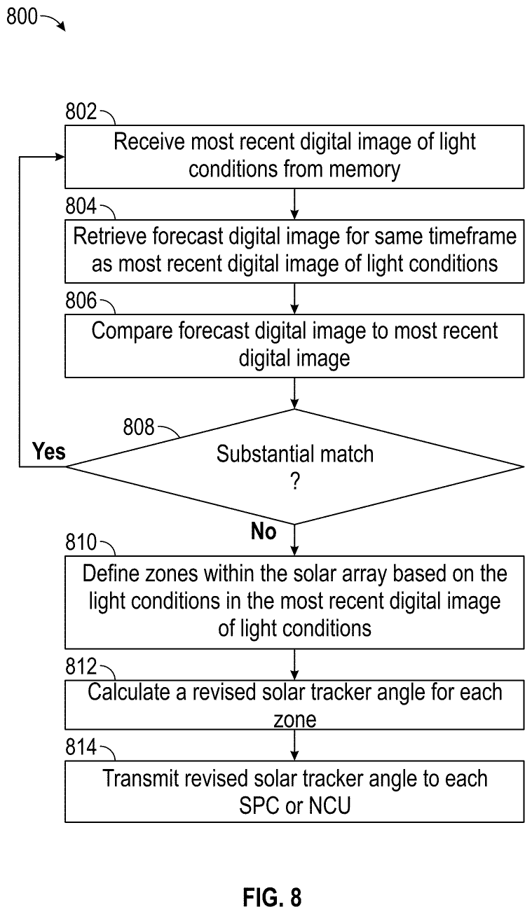

FIG. 2 shows a portion of the solar array 100 in accordance with one embodiment of the present disclosure. The solar array 100 is a distributed peer-to-peer network and includes multiple solar trackers 110. Each solar tracker is coupled to a corresponding self-powered controller (SPC) 114 and drive assembly 115 (e.g., a slew drive, FIG. 3). Each SPC 114 has logic for orienting its corresponding drive assembly 115 and thus solar tracker 110 based on orientation commands. As one example, an SPC 114 receives an orientation command from a network control unit (NCU) 122 to orient an incident angle θ between the solar tracker 110, and thus the solar modules 112 the solar tracker 110 supports, and the sun. The corresponding drive assembly 115 positions the solar tracker 110 to the angle θ. Each of the solar trackers 110 can be oriented independently of the other solar trackers 110.

Each of the solar trackers 110, and more particularly the solar modules 112 receives light, converts the light into electricity. That electricity may be stored in one or more batteries 116. The batteries 116 may be ganged together and electrically coupled through a distribution panel 118 to customer loads 120. Network control units (NCU) 122 are each wirelessly coupled to one or more of the SPCs 114. As shown in FIG. 1, NCUs 122 are wirelessly coupled to SPCs 114 and may both be coupled over an Ethernet cable to an NXFP switch 124. The switch 1240 couples NCUs to a Supervisory Control and Data Acquisition (SCADA) 126, which in turn is couple to a switch 128 coupled to a remote host 130 over a network such as a cloud network. In some embodiments, the remote host 130 performs processing such as generating performance models, retrieving weather data, to name only a few such tasks. For ease of reference, the combination of NCUs, SCADA 126 and NXFP switch 124 is referred to as an “SCU” system controller 132.

Preferably, each NCU 122 is coupled to each of the remaining NCUs thereby forming a mesh architecture. Thus, if for any reason an NCU 122 loses communication to the NX SCADA 126, NCU 122 can communicate with the NX SCADA 126 through another NCU. In other words, each NCU 122 acts as a gateway to the NX SCADA 126 for any other NCU 126. This added redundancy provides a fail-safe network owing to the NCUs being wirelessly coupled to each other.

Weather stations 134 collect local weather information. In one embodiment, the weather station 134 includes one or more sensors to determine direct normal irradiance (DNI), global horizontal irradiance (GHI), diffuse horizontal irradiance (DHI), any combination of these, ratios of any two of these (e.g., DHI/GHI), or any function of these such the diffuse faction irradiance (DFI). DNI, GHI, DFI, and DHI that can be used to generate performance models in accordance with the principles of the present disclosure. By fitting the weather conditions to output, a base performance model is determined using regression or other curve-fitting techniques. It will be appreciated that each solar tracker 110 may have its own performance model, based, among other things, on its topography and local weather conditions.

In a simplified example to account for diffuse light conditions parameters of the base performance model are pushed to a SPC 114 associated with a solar tracker 110 to orient the solar tracker 110 to a particular angle for a particular time of day and date. These parameters reflect an orientation for a solar panel module mounted on the solar tracker 110 if no adjustments for cloud cover are needed. To account for diffuse radiation caused for example such as cloud cover a diffuse angle adjustment may also be sent to the particular solar tracker 110. As one example, the parameters for a base performance model indicate that, for global optimization of the performance model, a solar panel module mounted on the solar tracker 110 should be oriented at an incidence angle of 10 degrees. Diffuse angle adjustor data indicate that 10 degrees is not optimal for this the solar module mounted on the solar tracker 110, but instead 70% (a factor of 0.7) of this angle should be used. Thus, the diffuse angle adjustor (gain factor) of 0.7 is pushed to the particular solar panel. When the particular SPC 114 receives both parameters, it orients its associated solar module mounted on the solar tracker 110 to an incidence angle of (0.7)*(10 degrees)=7 degrees. Preferably, the diffuse angle adjustment is performed periodically, such as once every hour, though other periods are able to be used.

Some embodiments may avoid shading in the morning, by using backtracking. The performance model thus generates some gain factors (e.g., target angles for orienting a solar tracker 110) for early morning tracking (to avoid shading) and another gain factor for other times. The system in accordance with these embodiments are said to operate in two modes: regular tracking and backtracking. That is, the system uses a backtracking algorithm (performance model) at designated times in the early morning and a regular tracking algorithm at all other times.

As will be appreciated, the above description of controlling for diffuse conditions is greatly simplified and accordingly produces less than maximum output of the solar array 100. As one example, there are often times when the cloud cover over the solar array 100 is not complete, that is only a portion of the solar array 100 may be shaded. An example of this can be seen in FIG. 1 where zone 102 outlines a portion of the solar array 100 currently experiencing cloud cover, while the remainder of the solar array 100 remains in full sun. As will be appreciated, the clouds will continue to move, and may impact other portions of the solar array 100 at different times through the day.

FIG. 3 depicts a further aspect of the disclosure. Specifically, in FIG. 3 the solar tracker 110 is shown in greater detail along with the solar modules 112 mounted on a torque tube 111 and a pier 113 and driven by a drive assembly 115. Also depicted in FIG. 3 is a reference solar panel 136. The reference solar panel 136 performs a variety of functions. As an initial matter the reference solar panel 136 is connected to a battery (not shown) which stores energy for actuating the drive assembly 115 in connection with instructions received from the SPC 114 and/or NCU 122. The reference solar panel 136 also provides data in the form of voltage and current values to the SPC 114 and/or NCU 122. These voltage and current values provide an indication of the DNI impacting the reference solar panel 136 at any given time as the solar tracker 110 follows its performance model. As will be appreciated if the DNI drops due to cloud coverage the voltage and current generated by the reference solar panel 136 will also drop. Through observation it can be determined that the value of the DNI for the solar modules 112 given solar tracker 110 has dropped below a GHI value for the solar tracker meaning that the solar tracker 110 and particularly the solar modules 112 can capture more radiation and thus generate more electricity if the solar modules 112 are re-oriented to a 0° or horizontal position. As noted above, this is generally referred to as the solar modules 112 and the reference solar panel 136 experiencing diffuse light conditions.

Though described herein as employing a reference solar panel 136 that is separate from the other solar modules 112 on the solar tracker 110, the disclosure is not so limited. Instead, the output from the solar modules 112 on the solar tracker 110 may similarly provide both the battery charging power to drive the drive assembly 115 as well as provide the voltage and current data for use in controlling the solar tracker 110 to the SPC 114 and/or NCU 122 as detailed below. This may be voltage and current data from one or more strings of solar modules 112 of the solar tracker 110.

In accordance with one aspect of the disclosure the solar array 100 is formed of a plurality of different zones. One such zone is the zone 102 depicted in FIG. 1. These zones may be constantly updated based on the observed local conditions. And the solar tracker 110 can be driven to a desired angle based on the zone in which they reside, and the light conditions estimated or experienced in that zone.

One aspect of the zone detection disclosure is directed to a method 400 to map irradiance observed or detected in the array 100 and to generate a digital image of the light conditions including cloud cover or near object shading within the array 100. At step 402 a variety of data is collected. The collected data may include current and voltage outputs from the strings of solar modules 112 or current and voltage data received from the reference solar panel 136. In some instances an adjustment may be applied to the received current and voltage data to account for degradation of the solar modules 112 over time. As is known, due to scratches on the surface of the solar module 112 and breakdown of the materials of the solar module 112 the output of any individual solar module 112 will decrease overtime thus the adjustment accounts for this degradation and allows for accurate subsequent processing. From the collected data the DNI, GHI, DFI, or DHI for each string of solar modules 112 of each tracker 110 in the array 100 or the reference solar panel 136 may be calculated. The collected data may also include one or more of DNI, GHI, DFI, or DHI collected by sensors associated with the weather station 134. The data may include other data collected by the weather station including wind speed and direction data, temperature data, humidity, barometric pressure, images acquired of the sky (e.g., cloud cover images), trend data such as change in wind speed or direction, temperature, humidity, and barometric pressure, and rates of change. The data may further include external weather forecast data including both publicly available forecast data and subscription based paid for services that may be acquired by the operator of the solar array 100. Still further, the data may include satellite images of the array 100 depicting the cloud cover and near object shading experienced by the array 100 at different times throughout the day.

The data collected at step 402 is used to map the irradiance experienced throughout the array 100 at step 404. This may include determining one or more of the DNI, GHI, DFI, and DHI for each tracker or string of solar modules 112 or the reference solar panel 136. It may also include comparing the determined DNI, GHI, DFI, and DHI to the satellite images, weather forecasts, and the data collected by the weather stations to confirm any cloudiness and near object shading.

At step 406 a digital image of the solar array 100 representative of the light conditions and the cloud cover or near object shading is generated. An example of the digital image 500 generated from the irradiance mapping (step 404) can be seen in FIG. 5.

At step 408 a series of the digital images 500 are captured and stored in a memory, for example a memory in the SCADA 126 or the remote host 130. As will be appreciated, the digital images 500 can be captured periodically (e.g., every 1 minute, 2 minutes, 5 minutes, 10 minutes, etc.) and stored in the memory to create a database of digital images 500. In FIG. 5, white represents zones that are under sunny skies, grey represents zones in excess of some threshold of cloudiness but perhaps not in a diffuse light condition, and black is under heavy cloud cover or near object shading (i.e., a diffuse light condition).

A second method 600 of the application is directed to generating a forecast digital image of light conditions throughout the array 100. The forecast digital image of light conditions may appear substantially the same as an actual digital image of light conditions 500. In accordance with the method 600, at step 602 a software application stored in the memory of the SCADA 126 or the remote host 130 receives the collected data (i.e., the same data collected at step 402 to generate the digital images) for the given time (i.e., real time collected data). At step 604 a plurality of successive digital images 500 are retrieved from the memory (e.g., the preceding 1, 2, 3, 4, 5, 10 or more digital images 500). An algorithm stored in the memory on the SCADA 126 or the remote host 130, such as an empirical algorithm or one developed using a neural network, learning algorithm, or artificial intelligence (AI) analyzes the real time data and the retrieved digital images 500 to generate a forecast digital image of the expected light conditions at some point in the future (e.g., 1, 2, 5, 10, 15, 20, 25, 30 or more minutes in the future) at step 606. These forecast digital images are then stored in a memory, such as one in the SCADA 126 or remote host 130 at step 608. The frequency of generation of the forecast digital images may be based on the frequency of movement of the solar tracker 110. Additionally or alternatively, the frequency may be based on the weather forecast for the area around the solar array 100. For example, if the forecast calls for cloud cover for an entire day, there is less need to undertake the generation of the forecast digital images as compared to a partly cloudy day where portions of the solar array 100 will change from cloud cover to full sun many times over the course of a day or even over the course of an hour.

A further aspect of the disclosure is directed to utilization of the forecast digital images generated in step 606 and stored in the memory to determine an angle of orientation to which each solar tracker 110 of the array 100 is to be driven to account for the shading or cloud cover experienced by each solar tracker 110. Each SPC 114, or NCU 122 which is in communication with a plurality of SPCs 114, stores locally a drive algorithm that specifies the position to which each solar tracker 110 is to be driven throughout the day during cloudless sky operation. This position may be compared to an actual position at which the solar tracker is positioned (e.g., data from a sensor on the solar tracker 110) and the SPC 114 or NCU 122 can provide corrective input to drive the solar tracker to a correct position based on the sun. The drive algorithm may account for some row-to-row shading or other near object shading by including backtracking as part of the standard drive algorithm for any given solar tracker 110 to drive one or more of the solar trackers 110 to a position other than normal to the sun's rays impacting the solar modules 112.

The method 700 of determining an angle to drive the solar tracker 110 of the array 100 starts at step 702 by receiving a forecast digital image from a memory. This is the forecast digital image for the next relevant time frame for the solar array 100 (e.g., 1, 2, 3, 5, 10, 15, or more minutes in the future). At step 704, this forecast digital image, is analyzed to define zones within the array 100 experiencing the same or similar light conditions. Considering the digital image 500, which is substantially similar to a forecast digital image, the areas of the digital image which have a similar color are experiencing the same or similar light conditions. In one aspect of the disclosure a zone is defined as contiguous portions of the solar array which are experiencing the same or similar light conditions. The zones are compared to a map of the solar array 100 to determine the solar trackers 110 which are found in each zone. In some instances, where a small and isolated portion of the array 100 is found to be surrounded by a larger contiguous portion, the small or isolated portion may be ignored and the small or isolated portion is treated as the same zone as the larger surrounding.

At step 706 the based on the light conditions for each zone in the forecast digital image an angle to which the solar trackers 110 within that zone are to be driven is calculated. This calculation may be based on a detected Hounsfield Unit value or brightness value of each zone. The darker the brightness value of a particular zone, the greater the amount of shading that zone is experiencing. As a result, a zone with a very dark brightness can be expected to generate more electricity if positioned in a 0° or substantially horizontal position. As will be appreciated, between the zones that are very bright and thus following normal tracking of the sun and very dark zones that may benefit from some change in orientation to increase DFI or to avoid some near object shading. These adjustments to the position of the solar trackers 110 are calculated. At step 708 these values are transmitted to the SPCs 114 or the NCU's 122 to drive the solar trackers 110 to a desired angle of orientation at the time coinciding with the time of the forecast digital image.

In this way, the changes in cloud cover and near object shading experienced by the solar array 100 and individual solar trackers 110 can be predicted and the solar trackers 110 driven to an orientation to maximize the output of the solar array 100 at the predicted time of the forecast digital image.

Those of skill in the art will recognize that the forecast digital images and the zones and solar tracker 110 angles calculated for each zone may not be accurate, or may reflect inaccurate assumptions or calculations. Accordingly, a further aspect of the disclosure is a check and correction of calculated solar tracker angles transmitted to the SPCs 114 or NCU's 122. A method 800 describes the check and correction by comparing an actual digital image 500 of the light conditions to a forecast digital image. As will be appreciated the actual digital image 500 is the most recent digital image 500 generated by the algorithm as described in method 400, and is the closest digital image 500 in time to the time for which the forecast digital image is generated.

At step 802 the most recent digital image 500 of light conditions is received from memory. The forecast digital image closest in time to the most recent digital image 500 is retrieved from memory at step 804. The method compares the digital image 500 and the forecast digital image. At step 808, if they are a substantial match then the method returns to step 802 and repeats as needed such that every forecast digital image is compared to an actual digital image 500 of the light conditions at the forecast time. The similarity of the digital image 500 and the forecast digital image may be based by comparing the brightness and locations of the brightness in the two digital images.

If however, the result of the comparison is that the two images are not substantially similar, the method proceeds to step 810, where the most recent digital image of the light conditions is analyzed similar to as undertaken in step 704 to define zones in the digital image 500. At step 814 based on the determination of the zones revised solar tracker angles are calculated. This calculation of the revised solar tracker angles is undertaken in a similar manner to the calculation of the solar tracker angles in step 706 of method 700. Finally, the revised solar tracker angels are transmitted to the SPCs 114 or the NCUs 122.

Method 800 may be undertaken immediately before the SPCs 114 or NCU's 122 cause the drive assembly 115 to rotate the solar trackers 110 to the angle determined by method 700. Alternatively, method 800 may be taken after the SPC's 114 or NCU's 122 cause the drive assembly 115 to start driving the drive assembly 115 and can be used to alter the position to which the SPCs 114 or NCU 122 drive the solar trackers 110.

Those of ordinary skill in the art will recognize that the methods 400, 600, 700, and 800 may operate serially or in parallel. Additionally, the methods 400, 600, 700, and 800 may occur independently of one another.

It will be appreciated that each of the SPCs, NCUs, and SCADA described herein comprises a computer readable memory containing computer-executable instructions, a processor for performing those instructions, a transmitter/receiver for transmitting and receiving information for execution of those instructions by another element of the systems as described herein.

At each interval that the zones are calculated any individual solar tracker 110 may be defined in a zone different from the zone of the preceding calculation. Thus, individual solar trackers can be controlled to change their orientation as clouds pass over the array 100. As noted above, the methods described herein are particularly useful for very large arrays 100, such as those in excess of a mile or more across. For example, the array depicted in FIG. 5 is over 3.4 miles in width.

The movement of the solar trackers 110 is also controlled by other limits. For example, there may be a slight delay before identifying an individual solar tracker 110 to be within a zone that would require its movement. As is known any perceived increase in output of a solar tracker 110 achievable by moving to horizontal position to maximize the radiation absorbed by the solar modules 112 must be balanced by the energy required to move the solar tracker 110 to this position. If based on the image analyses it appears that the zones are changing from sunny to cloudy to sunny at a relatively fast rate, a determination may be made that the net energy generation is actually better if the solar tracker 110 stays in a sub-optimal position when factoring in the energy required for the initial movement, and the subsequent return to a normal tracking position. As a general rule the solar array 100 should be relatively slow to end normal tracking of the solar trackers 110 and to place the solar modules 112 in a horizontal position associated with diffuse light conditions. Similarly, the solar array 100 should be relatively quick to have the solar tracker 110 exit the horizontal position associated with diffuse light conditions and to return to normal tracking as soon as possible owing to the local cloudiness.

A further aspect of the disclosure is directed to the training of neural networks or predictive algorithms. Using the actual digital images 500 of light conditions, the neural network may be trained to predict the movement of the clouds over the array 100. This prediction may be used to allow the anticipation of changes in cloud cover to generate the forecast digital image of light conditions of method 600. These changes can shorten the buffer times for directing the SPC 114 to drive the solar tracker 110 to a horizontal position were based on the predictions the duration of the solar tracker being in a cloudy zone will be sufficient to warrant being in this position. Similarly, the timing for returning to normal tracking can be shortened such that the movement can be in near real time as the tracker emerges from the cloud cover or even slightly before where it is determined that the increase in production for being in a normal tracking position immediately upon exiting of a cloudy zone outweighs and intermediate loss of generation by no longer being in a horizontal position which is generally considered optimal for diffuse light conditions. As note above, all movements of the solar trackers 110 are considered in view of the energy used to move the solar tracker 110 in comparison to the gains in energy capture and production.

The forgoing provides a systems and method for controlling a large solar array 100 and allow for the definition of multiple zones within the array 100. The zones are defined via image processing of the digital images 500 and the forecast digital images as described above The zones may be redefined based on size of a zone or the presence of a GHI sensor within the zone. Once redefined, the determination of which zone each solar tracker is in is transmitted to the SPCs 114 or the NCUs 122.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects.

We claim:

1. A method of controlling a solar array comprising:
receiving current and voltage data from a plurality of solar modules of the solar array;
calculating a diffuse fraction irradiance (DFI) for the plurality of solar modules;
mapping the diffuse fraction irradiance for the plurality of solar modules;
generating a digital image of light conditions in the solar array based on the mapped diffuse fraction irradiance;
defining zones within the array based on the light conditions in the digital image;
determining a zone-specific solar tracker angle for each zone based on mapped diffuse fraction irradiance;
transmitting the zone-specific solar tracker angle to a computing device associated with each solar tracker in the solar array; and
driving the solar trackers such that the solar trackers that make up each zone are oriented to substantially the same angle.

2. The method of claim 1, further comprising storing the digital image of light conditions in a memory.

3. The method of claim 2, further comprising generating a forecast digital image of light conditions in the solar array and storing the forecast digital image of light conditions in a memory.

4. The method of claim 3, further comprising receiving a stored forecast digital image of light conditions; and
comparing the received stored forecast digital image of light conditions to a most recent digital image of light conditions, wherein if there is a substantial match zones defined from the stored forecast digital image of light conditions and solar tracker angles calculated for each zone are transmitted to the computing device associated with each solar tracker in the solar array.

5. The method of claim 4, wherein if there is no substantial match the method further comprises:
defining zones within the array based on the light conditions in the most recent digital image of light conditions in the array;
determining a zone-specific solar tracker angle for each zone based on mapped diffuse fraction irradiance in the most recent digital image of light conditions in the array; and
transmitting the zone-specific solar tracker angle to a computing device associated with each solar tracker in the solar array.

6. The method of claim 1, wherein the computing device is one of a self-powered controller (SPC) or a network control unit (NCU).

7. The method of claim 1, further comprising adjusting the received current and voltage data to account for degradation of the solar modules supported by the solar trackers.

8. The method of claim 1, further comprising determining one or more of direct normal irradiance (DNI), global horizontal irradiance (GHI), diffuse horizontal irradiance (DHI), any combination of these.

9. The method of claim 8, further comprising receiving one or more of a satellite images, weather forecasts, and data collected by weather stations.

10. The method of claim 9, further comprising comparing the satellite images, weather forecasts, or data collected by weather stations to one or more of the DNI, GHI, DFI, and DHI to confirm any cloudiness and near object shading.
